(19) United States
(12) Patent Application Publication
(10) Pub. No.: US 2020/0307038 A1
(43) Pub. Date: Oct. 1, 2020

(54) MOLDING METHOD, MOLDING APPARATUS, IMPRINT METHOD, METHOD FOR MANUFACTURING ARTICLE, AND ARTICLE MANUFACTURING SYSTEM

(71) Applicant: CANON KABUSHIKI KAISHA, Tokyo (JP)

(72) Inventors: Takahiro Nakayama, Haga-gun (JP); Shintaro Narioka, Utsunomiya-shi (JP)

(21) Appl. No.: 16/827,449

(22) Filed: Mar. 23, 2020

(30) Foreign Application Priority Data
Mar. 26, 2019 (JP) 2019-059215

(51) Int. Cl. B29C 43/58; B29C 33/42

(52) U.S. Cl. CPC B29C 43/58; B29C 33/424; B29C 2043/5825; B29C 2043/5808; B29C 2043/5833

(57) ABSTRACT

An imprint method brings a mold into contact with an imprint material placed on a base layer on a substrate and cures the imprint material, thereby obtaining a cured product onto which a shape of the mold is transferred. The imprint method includes making position adjustment of the mold and the substrate in a state where the mold and the base layer of the substrate are in contact with the imprint material, measuring an in-plane distribution of a shearing force generated when the position adjustment is made, and determining an application condition of the base layer based on a result of the measurement.

### BACKGROUND

### Field of the Disclosure

The present disclosure relates to a molding method, a molding apparatus, an imprint method, a method for manufacturing an article, and an article manufacturing system.

### Description of the Related Art

As a technique for molding a curable composition on a substrate, an imprint technique is known. A light curing method is one of imprint techniques. In the imprint method based on the light curing method, first, an uncured imprint material (occasionally referred to as “photo-curable composition” or “photo-curable resin”) is supplied onto a substrate (e.g., a wafer). Next, imprint material on the substrate and a mold are brought into contact with each other (a pressing step). Then, light (ultraviolet light) is emitted to the imprint material in the state where the imprint material and the mold are in contact with each other (a curing step), thereby curing the imprint material. After the imprint material is cured, the distance between the substrate and the mold is widened (a releasing step). Accordingly, the mold is pulled away from the cured imprint material, and a resin pattern is formed on the substrate.

In the state where the imprint material and the mold are in contact with each other, an imprint apparatus needs to adjust the position of a pattern formed in advance on the substrate (a substrate side pattern) with the position of a pattern formed in the mold (a mold pattern portion). In the position adjustment between the substrate and the mold, the substrate and the mold are moved relative to each other, whereby a force acts in a direction opposite to the relative moving direction of the substrate and the mold due to viscoelasticity of the imprint material. This force is referred to as a “shearing force”. In the position adjustment between the substrate and the mold, the shearing force may cause distortion in a plane between the substrate and the mold. The distortion in the plane between the substrate and the mold caused by the shearing force decreases the accuracy of the position adjustment between the substrate and the mold.

Japanese Patent Application Laid-Open No. 2015-29073 discusses a method for causing condensable gas to permeate an imprint material, thereby increasing the film thickness of the imprint material, reducing the shearing force of the imprint material, and improving the accuracy of position adjustment.

Meanwhile, Japanese Patent Application Laid-Open No. 2016-58735 discusses a method for emitting light to an imprint material simultaneously with or before the position adjustment between a substrate and a mold. A purpose of the method is to prevent the deterioration of the positional accuracy caused by a disturbance such as the vibration of an apparatus due to low viscoelasticity. The method increases the shearing force of the imprint material, and thereby improving the accuracy of the position adjustment.

In a case where imprint is performed in each of different areas on the substrate, the result of the imprint differs from area to area due to the occurrence of distortion or a defect only in a particular area, depending on the application state of a base layer or the state of the surface of the substrate to which the base layer is applied.

For example, in a case where the thickness of the base layer is distributed in the plane of the substrate, the distribution of the shearing force may occur in the plane of the substrate, or influence on imprint may differ if particles are stuck.

However, Japanese Patent Application Laid-Open No. 2015-29073 and 2016-58735 do not discuss a method considering an influence on imprint in different areas on a base layer.

If imprint is performed in each area in the state where the shearing force is distributed in the plane, distortion occurs in some of the areas when the position adjustment between the substrate and the mold is made. This decreases the accuracy of the position adjustment.

### SUMMARY

The present disclosure is directed to providing a molding method for achieving suitable imprint over the entire surface of a substrate.

According to an aspect of the present disclosure, a molding method for placing a curable composition on a substrate including a base layer on a surface of the substrate and obtaining a cured product molded on the substrate using a mold includes making position adjustment between the mold and the substrate in a state where the mold and the base layer of the substrate are in contact with the curable composition, measuring an in-plane distribution of a shearing force generated when the position adjustment is made, or an in-plane distribution of a film thickness of the base layer, and determining an application condition of the base layer or a detection condition for alignment detection through the base layer based on a result of at least one of the in-plane distribution of the shearing force and the in-plane distribution of the film thickness of the measuring step.

Further features of the present disclosure will become apparent from the following description of exemplary embodiments with reference to the attached drawings.

### BRIEF DESCRIPTION OF THE DRAWINGS

FIG. 1 is a flowchart of an imprint method according to a first exemplary embodiment.

FIG. 2 is a block diagram illustrating a system configuration according to the first exemplary embodiment.

FIG. 3 is a diagram illustrating an imprint apparatus according to the first exemplary embodiment.

FIG. 4 is a diagram illustrating a distribution of a shearing force according to the first exemplary embodiment.

FIG. 5 is a flowchart of an imprint method according to a second exemplary embodiment.

FIG. 6 is a diagram illustrating an in-plane distribution of a film thickness of a base layer according to the second exemplary embodiment.

FIG. 7 is a flowchart of an imprint method according to a third exemplary embodiment.

FIG. 8 is a diagram illustrating an imprint apparatus according to the third exemplary embodiment.

FIG. 9 is a flowchart of an imprint method according to a fourth exemplary embodiment.

FIG. 10 is a diagram illustrating a particle detection apparatus according to the fourth exemplary embodiment.

### DESCRIPTION OF THE EMBODIMENTS

Desirable exemplary embodiments of the present disclosure will be described in detail below based on the attached drawings.

In the following exemplary embodiments, a detailed description is given of an imprint method and an imprint apparatus for placing on a substrate an imprint material that is a curable composition and forming a pattern of a cured product on the substrate using a mold having an uneven pattern (e.g., concave-convex pattern) on its surface. The present disclosure, however, is not limited to this, and is also applicable to, for example, a molding method and a molding apparatus for a planarization apparatus for forming a flat surface on a substrate using a flat mold.

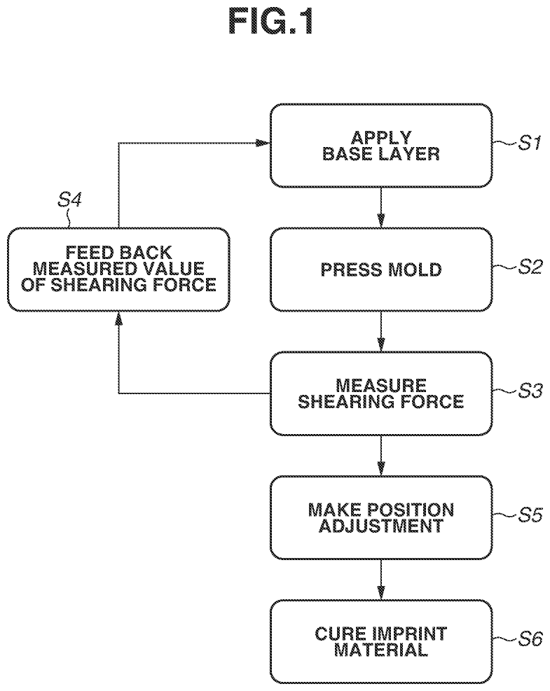

FIG. 1 is a diagram illustrating the flow of an imprint method according to a first exemplary embodiment. In the drawings, similar members are designated by the same reference numbers, and are not redundantly described. In the following figures, an axis in the vertical direction is a Z-axis, and two axes orthogonal to each other in a plane perpendicular to the Z-axis are an X-axis and a Y-axis.

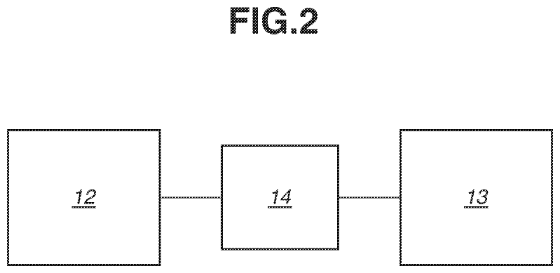

FIG. 2 illustrates an article manufacturing system using the imprint method according to the present exemplary embodiment. The article manufacturing system includes an application apparatus 13 as a preprocessing apparatus that applies a base layer to a substrate, and an imprint apparatus 12 that places an imprint material (e.g., a curable composition) on the substrate to which the base layer is applied, and performs imprint. The article manufacturing system further includes a control unit 14 (e.g., a computer) connected to the application apparatus 13 and the imprint apparatus 12.

The control unit 14 may be built into either of the apparatuses, or may be an external control unit. A configuration may be employed in which the application apparatus 13, the imprint apparatus 12, and the control unit 14 are connected to each other via the Internet.

In step S1, before the imprint apparatus 12 performs imprint, a method for manufacturing an article according to the present exemplary embodiment applies a base layer 1 to a place on a substrate 9 onto which a pattern is to be transferred, using the application apparatus 13 as the preprocessing apparatus.

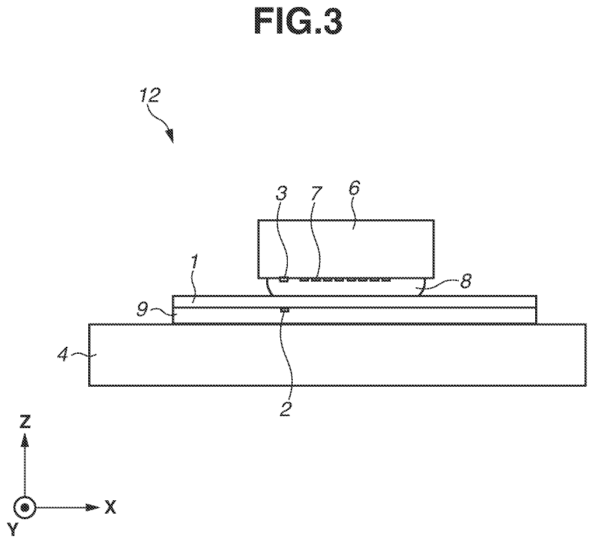

As the application apparatus 13, an application apparatus termed a coater/developer is used as an example. For applying the base layer 1, a spin coating process and a baking process are used. As the material of the base layer 1, for example, spin-on carbon (SOC) is used. As illustrated in FIG. 3, the base layer 1 is a layer between a mold alignment mark 3 on the mold side and a substrate alignment mark 2 on the substrate side. The base layer 1 may be a single layer or a multilayer.

The substrate 9 on which the base layer 1 has been applied by the application apparatus 13 is conveyed to the imprint apparatus 12 illustrated in FIG. 3 by a conveying system (not illustrated). The pattern of an imprint material 8 is formed, by a mold 6, on the surface of the substrate 9, which has been conveyed to the imprint apparatus 12. For example, a silicon (Si) wafer is used for the substrate 9, which also includes a Si wafer on the surface of which a multilayered structure and a pattern are formed through a plurality of processes. Specifically, the imprint material 8 is cured in a state where the mold 6 and the imprint material 8 are in contact with each other, and the mold 6 is pulled away from the cured imprint material 8. Accordingly, a cured product pattern of a three-dimensional shape (e.g., an uneven pattern) formed in a pattern portion 7 of the mold 6 is transferred onto the imprint material 8.

In the present exemplary embodiment, a photo-curable composition is used as the imprint material 8.

An imprint head (not illustrated) holds the mold 6 with a vacuum suction force or an electrostatic force. The imprint head is configured to drive the mold 6 in the Z-axis direction. In step S2, when bringing the pattern portion 7 and the imprint material 8 into contact with each other, the imprint head lowers and presses the mold 6 in the −Z-direction.

In step S3, the shearing force of the imprint material 8 is measured, in the state where the mold 6 is lowered and pressed in the −Z-direction.

A wafer stage 4 illustrated in FIG. 3 moves while holding the substrate 9 with a vacuum suction force or an electrostatic force. The wafer stage 4 can move by a driving mechanism (not illustrated), such as a linear motor and a piezo actuator. The driving mechanism may include a fine driving system for moving the wafer stage 4 by a minute amount, and a coarse motion driving system for moving the wafer stage 4 by an amount of movement greater than that of the fine driving system. Since the wafer stage 4 is positioned below the mold 6 for imprint process, the wafer stage 4 is mainly positioned in the XY-plane by a positioning control system. The moving direction of the wafer stage 4, however, is not limited to this. The wafer stage 4 may be configured to move in the X-axis direction, the Y-axis direction, the Z-axis direction, and rotational directions about these axes.

While the wafer stage 4 moves in the horizontal direction, the distance between the surface of the substrate 9 and the mold 6 is maintained at 1 mm or less. With such a narrow gap, it is possible to quickly perform the operation of bringing the mold 6 and the imprint material 8 into contact with each other and the operation of pulling the mold 6 and the imprint material 8 away from each other in the imprint process.

In the state where the mold 6 is pressed (i.e., the state where the imprint material 8 is in contact with the substrate 9 and the mold 6), the substrate 9 and the mold 6 are moved relative to each other in the X-direction or the Y-direction, whereby a force acts in a direction opposite to the relative moving direction of the substrate 9 and the mold 6 due to the viscoelasticity of the imprint material 8. This force is referred to as a “shearing force”.

When the mold 6 is fixed, and the wafer stage 4 is positioned in the XY-plane, the driving force of the wafer stage 4 increases to balance the shearing force generated in the direction opposite to the relative moving direction.

In step S3, the driving force of the wafer stage 4 is detected, thereby measuring the shearing force generated in the imprint material 8 when the mold 6 and the wafer stage 4 move relative to each other.

The measured value of the shearing force is obtained in each of a plurality of imprint shot areas on the substrate 9. Consequently, it becomes possible to obtain the in-plane distribution of the shearing force on the substrate 9, i.e., the base layer 1.

In step S4, the measurement result of the shearing force measured in step S3 is fed back to the preprocessing apparatus (not illustrated). Based on information regarding the fed back shearing force, the control unit 14 determines the application condition of the base layer 1 (an application condition determination step), and changes the application condition in the application apparatus 13.

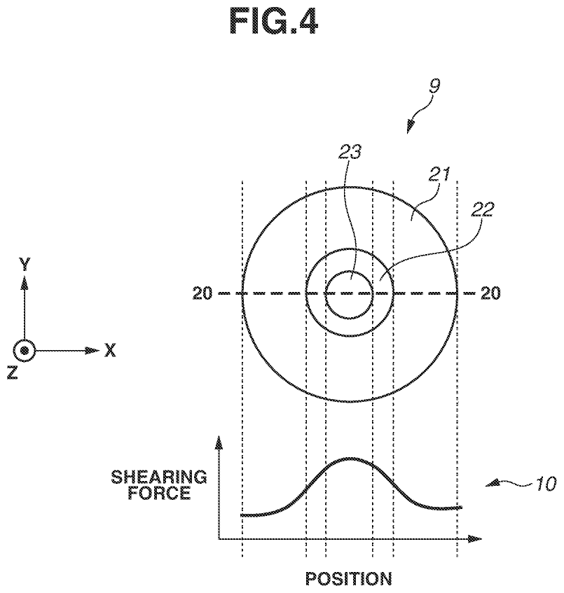

FIG. 4 illustrates a case where the shearing force is concentrically distributed on the substrate 9. The substrate 9 is divided from its center into an area 23 where the shearing force is large, an area 22 where the shearing force is medium, and an area 21 where the shearing force is small. A distribution 10 indicating the in-plane distribution of the shearing force represents a profile at an observation position 20 of the shearing force, where the horizontal axis is the position, and the vertical axis is the shearing force.

The present inventors have focused on the issue that a difference occurs in the distribution of the shearing force on the surface of the substrate 9, whereby distortion or a positional shift occurs in a cured pattern to be formed.

After diligent consideration of this issue, the present inventors have newly found out that the shearing force acting on the imprint material 8 when position adjustment is made depends on the state of the base layer 1, specifically, the film thickness of the base layer 1. The present disclosure has been made based on this.

That is, the present disclosure is based on new knowledge that if the film thickness of the base layer 1 applied to the same substrate or a plurality of substrates created under the same condition is made larger, the shearing force acting on the imprint material 8 when position adjustment is made can be made smaller.

To reduce the difference in the in-plane distribution of the shearing force, steps S1 to S4 are repeated until the shearing force in each imprint shot area in the plane falls within an acceptable range. Alternatively, after steps S1 to S4 are repeated as many times as determined in advance, the processing may proceed to step S5.

If the shearing force in one or more imprint shots falls within the acceptable range in a certain substrate 9, the application condition of the preprocessing apparatus (not illustrated) may be fixed, and another substrate 9 may be imprinted.

Alternatively, after the imprint process is performed on as many substrates 9 as determined in advance, steps S1 to S4 can be performed again. For example, every time the imprint process is performed on 25 substrates 9, steps S1 to S4 can be performed again. Thus, the imprint process can be advanced while confirming that the substrates 9 do not vary due to individual differences between substrates 9, or are not influenced by preprocessing.

In step S5, the position adjustment between the mold 6 and the substrate 9 is made (a position adjustment step). As illustrated in FIG. 3, the position adjustment of the mold 6 and the substrate 9 is made by detecting the mold alignment mark 3 corresponding to the pattern portion 7 formed on the mold 6, and the substrate alignment mark 2 corresponding to a pattern (not illustrated) formed on the substrate 9. The pattern (not illustrated) includes a shot area where a pattern is formed in advance on the substrate 9. That is, the position adjustment between the mold 6 and the substrate 9 is the superimposition of the pattern portion 7 and the shot area. The position adjustment between the mold 6 and the substrate 9 may include the step of changing the shape of the mold 6 (the pattern portion 7).

The position adjustment between the mold 6 and the substrate 9 is made by moving the wafer stage 4 in the XY-plane. As a result, it is also possible to perform the shearing force measurement in step S3. The shearing force measurement in step S3 may be performed simultaneously with the position adjustment step in step S5.

In step S6, the pattern formed in the imprint material 8 by the mold 6 is cured. The imprint head (not illustrated) emits, to the imprint material 8, light having a wavelength that cures the imprint material 8, thereby curing the imprint material 8. The light having the wavelength that cures the imprint material 8 may be an electromagnetic wave that cures the imprint material 8, such as ultraviolet light.

To pull the mold 6 away from the cured imprint material 8, the mold 6 is lifted in the +Z-direction, and the substrate 9 is carried out of the imprint apparatus 12.

In the imprint method as described above, the measurement result of the shearing force is fed back to the preprocessing apparatus, whereby it is possible to improve the accuracy of the position adjustment between the substrate 9 and the mold 6.

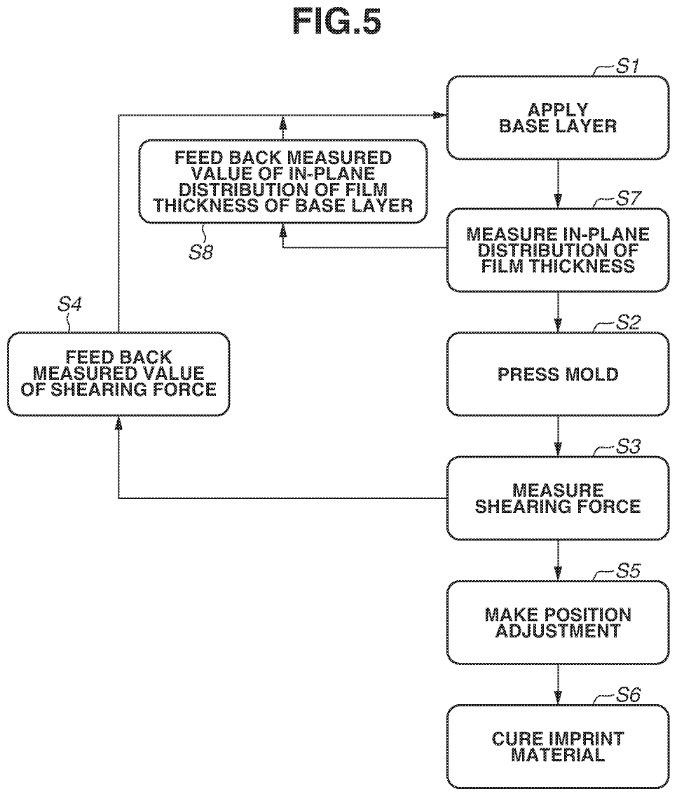

Next, an imprint method according to a second exemplary embodiment is described with reference to FIG. 5. FIG. 5 is a diagram illustrating the flow of the imprint method according to the second exemplary embodiment. The imprint method according to the present exemplary embodiment is different from that according to the first exemplary embodiment in that, as illustrated in FIG. 5, the measured value of the in-plane distribution of the film thickness of the base layer 1 is fed back to the preprocessing apparatus (not illustrated) (step S8).

In FIG. 5, after the base layer 1 is applied to the substrate 9 by the preprocessing apparatus (not illustrated), then in step S7, the in-plane distribution of the film thickness of the base layer 1 is measured. A measurement unit that measures the in-plane distribution of the film thickness of the base layer 1 may be included in any of the preprocessing apparatus (not illustrated), the imprint apparatus 12, and an external measurement apparatus. It is, however, desirable that the imprint apparatus 12 should include the measurement unit.

As a measurement method performed by the measurement unit, optical measurement is desirable to prevent the contamination of the substrate 9. For example, spectroscopic ellipsometry is used. The base layer 1 may be a multilayer. In a case of a multilayer, the in-plane distribution of the film thickness of each layer is obtained as a measured value.

In step S8, the measured value of the in-plane distribution of the film thickness of the base layer 1 is fed back to the preprocessing apparatus (not illustrated). Based on information regarding the fed back in-plane distribution of the film thickness of the base layer 1, the preprocessing apparatus (not illustrated) determines the application condition of the base layer 1 and changes the current application condition to the determined application condition.

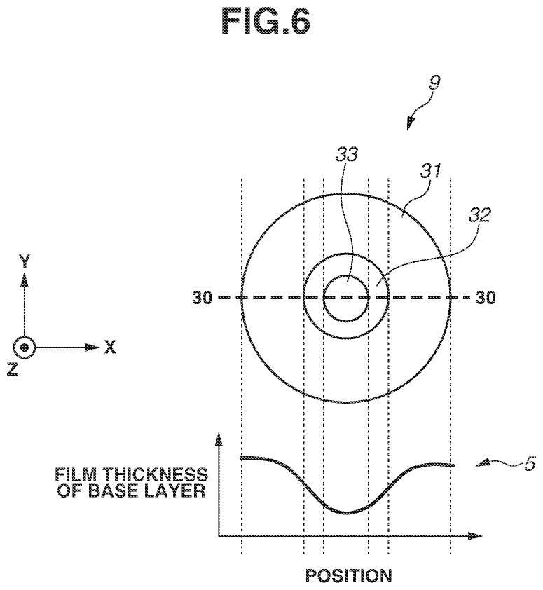

FIG. 6 illustrates a case where the in-plane distribution of the film thickness of the base layer 1 is concentric on the substrate 9. The substrate 9 is divided from its center into an area 33 where the film thickness is small, an area 32 where the film thickness is medium, and an area 31 where the film thickness is large. An in-plane distribution 5 of the film thickness of the base layer 1 represents a profile at an observation position 30 of the film thickness, where the horizontal axis is the position, and the vertical axis is the film thickness of the base layer 1.

As described above, it has been found out that the shearing force acting on the imprint material 8 depends on the film thickness of the base layer 1. That is, if the film thickness of the base layer 1 is made larger, the shearing force acting on the imprint material 8 becomes smaller. In response, based on information regarding the distribution of the film thickness of the base layer 1, the application condition is determined such that the film thickness of the base layer 1 becomes uniform, and the current application condition is changed to the determined application condition, whereby it is possible to reduce the deviation of the difference in height in the distribution of the shearing force.

That is, the application condition of the base layer 1 can be set to an application condition having the distribution of the film thickness obtained by changing the film thickness of the base layer 1 such that the difference in height in the distribution of the shearing force between a plurality of areas on the substrate 9 becomes small.

Particularly, the application condition may be determined such that the film thickness of the base layer 1 increases in response to an increase in the shearing force generated in the peripheral direction from the center of the substrate 9.

There is also a case where a pattern is formed on the substrate 9 before the imprint apparatus 12 performs the imprint process. In such a case, even if the distribution of the film thickness of the base layer 1 is uniform on the substrate 9, the shearing force may be ununiformly distributed on the substrate 9.

It is considered that this distribution of the shearing force is caused by the unevenness of the pattern formed in advance.

In response, an optimal application condition may be determined based on information regarding both the distribution of the shearing force of the substrate 9 fed back to the preprocessing apparatus (not illustrated) in step S4 and the distribution of the film thickness of the base layer 1 fed back in step S8. In this case, priority may be given to the distribution of the shearing force, and the distribution of the film thickness of the base layer 1 may be positively provided.

In the imprint method as described above, it becomes possible to improve the accuracy of the position adjustment between the substrate 9 and the mold 6, by feeding back the measured value of the in-plane distribution of the film thickness of the base layer 1 to the preprocessing apparatus (not illustrated).

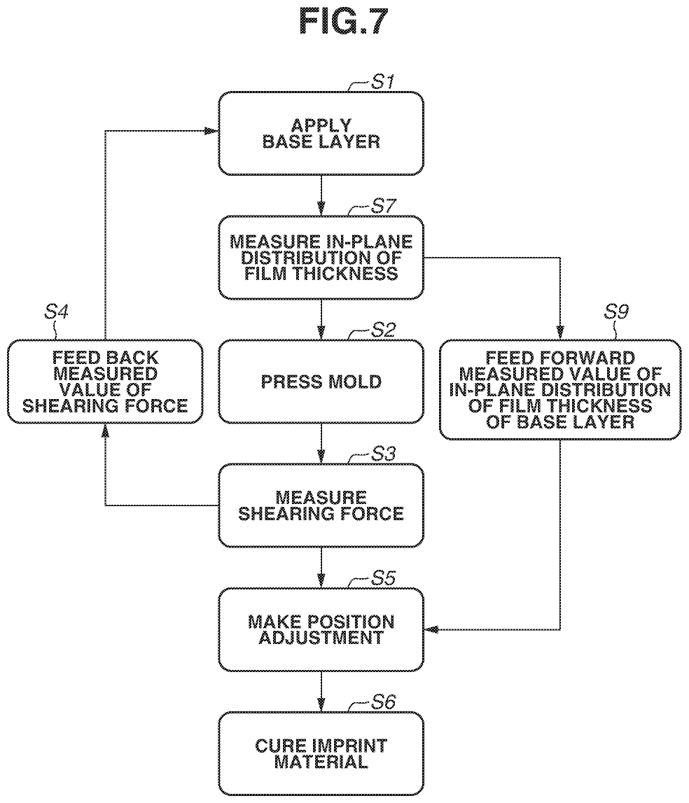

Next, an imprint method according to a third exemplary embodiment is described with reference to FIG. 7. FIG. 7 is a diagram illustrating the flow of the imprint method according to the third exemplary embodiment. The imprint method according to the present exemplary embodiment is different from those according to the first and second exemplary embodiments in that as illustrated in FIG. 7, the measured value of the in-plane distribution of the film thickness of the base layer 1 is fed forward to the imprint apparatus 12 (step S9).

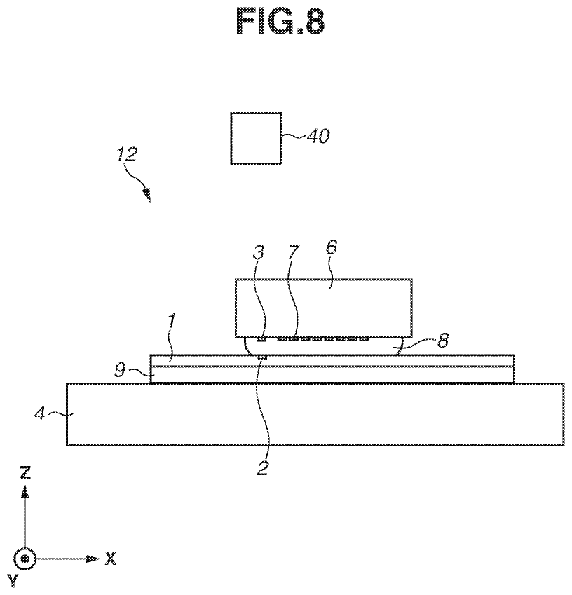

In FIG. 7, after the in-plane distribution of the film thickness of the base layer 1 is measured in step S7, then in step S9, the in-plane distribution of the film thickness of the base layer 1 is fed forward to the imprint apparatus 12. In FIG. 8, the imprint apparatus 12 changes a condition for the position adjustment between the substrate 9 and the mold 6, based on information regarding the fed forward in-plane distribution of the film thickness of the base layer 1.

The position adjustment of the mold 6 and the substrate 9 is performed by an alignment detection unit 40 detecting the mold alignment mark 3 and the substrate alignment mark 2. The alignment detection unit 40 includes a light emission device that illuminates the mold alignment mark 3 and the substrate alignment mark 2, and a detection unit that detects light reflected and scattered by both alignment marks.

If the film thickness of the base layer 1 becomes large, the light reflected and scattered by the mold alignment mark 3 and the substrate alignment mark 2 is absorbed by the base layer 1, and the detection intensity of the light being detected by the alignment detection unit 40 becomes weak. This results in decreasing the accuracy of the position adjustment. In response, the wavelength and the amount (the intensity) of the light to be emitted from the alignment detection unit 40 is optimized according to the film thickness of the base layer 1, based on information regarding the in-plane distribution of the film thickness of the base layer 1 fed forward in step S9.

The absorption of the light by the base layer 1 has wavelength dependence. Thus, the detection intensity of the light by the alignment detection unit 40 can be improved by selecting a wavelength that is less absorbed. If the intensity of the light to be emitted to the alignment marks is increased, the intensity of the light to be reflected and scattered by the alignment marks increases. Thus, the detection accuracy of the light by the alignment detection unit 40 is improved. The position adjustment between the substrate 9 and the mold 6 can be made with more accuracy by selecting the wavelength and the light intensity of alignment light based on information regarding the in-plane distribution of the film thickness of the base layer 1.

As described above, in the imprint method, the measured value of the in-plane distribution of the film thickness of the base layer 1 is measured, and based on the measurement result, a detection condition for subsequent alignment detection through the base layer 1 is determined. That is, the accuracy of the position adjustment between the substrate 9 and the mold 6 can be improved, by feeding forward the measurement result to the imprint apparatus 12.

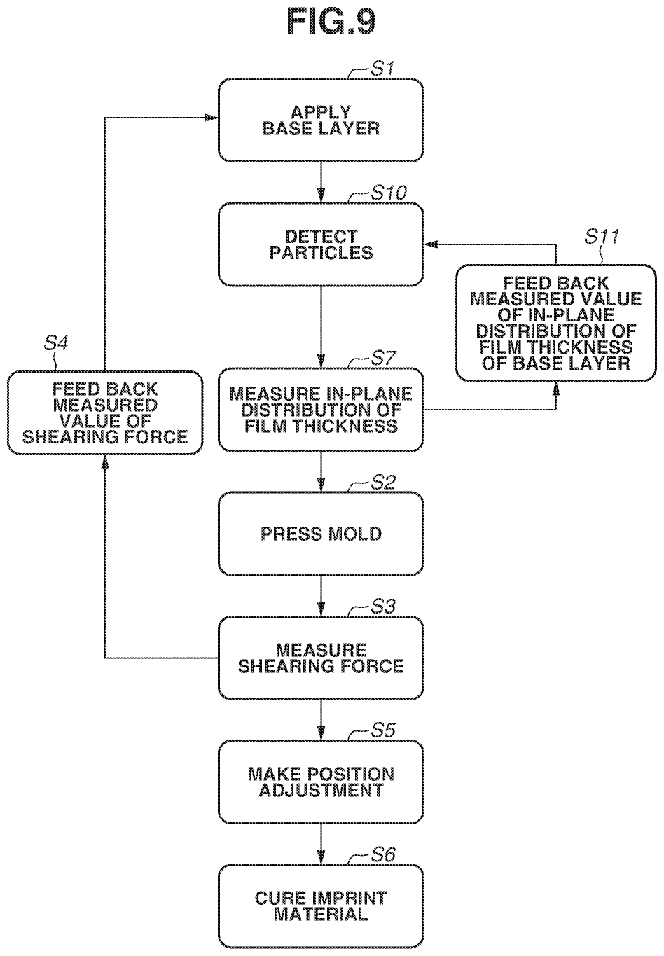

Next, an imprint method according to a fourth exemplary embodiment is described with reference to FIG. 9. FIG. 9 is a diagram illustrating the flow of the imprint method according to the fourth exemplary embodiment. The imprint method according to the present exemplary embodiment is different from those according to the first to third exemplary embodiments in that, as illustrated in FIG. 9, the measured value of the in-plane distribution of the film thickness of the base layer 1 is fed back to a particle detection apparatus 53 (step S11).

As illustrated in FIG. 9, after the base layer 1 is applied to the substrate 9 by the preprocessing apparatus (not illustrated), then in step S10, the particle detection apparatus 53 detects particles on the base layer 1 (a particle detection step).

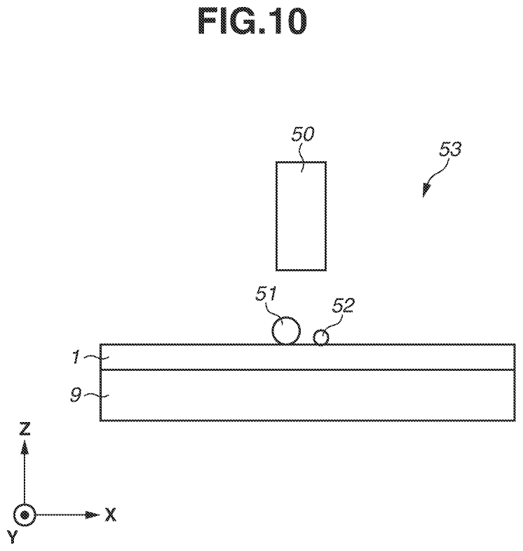

FIG. 10 illustrates a part of the particle detection apparatus 53. The particle detection apparatus 53 emits light to particles attached to the surface of the base layer 1 and detects the light reflected and scattered by the particles, thereby measuring the number and the sizes of the particles.

A particle detection unit 50 includes an emission mechanism that emits light to particles, and a detection mechanism that detects the light reflected and scattered by the particles. The particle detection apparatus 53 includes a substrate stage (not illustrated). The particle detection apparatus 53 rotates the substrate 9 and performs XY scan on the substrate 9, and thereby can measure the distribution of particles on the base layer 1.

FIG. 10 illustrates a large particle 51 and a small particle 52. The larger the particle size is, the greater the intensity of light to be reflected and scattered is. If many particles are attached to the base layer 1, the particle detection apparatus 53 can provide a threshold for the particle size and detect only particles of sizes larger than the threshold. The particle detection apparatus 53 may be a part of the imprint apparatus 12.

In step S2, the imprint apparatus 12 brings the mold 6 and the substrate 9 into contact with each other with the imprint material 8 between the mold 6 and the substrate 9. As illustrated in FIG. 10, the large particle 51 and the small particle 52 are attached to the base layer 1. At this time in a case where a particle of a size larger than or equal to an acceptable value is attached to the base layer 1, the particle may destroy the mold 6 when the mold 6 and the substrate 9 are brought into contact with each other with the imprint material 8 between the mold 6 and the substrate 9. In step S10, particles on the base layer 1 are detected, whereby it is possible to detect a large particle of a size larger than or equal to the acceptable value in advance and prevent the mold 6 from being destroyed. If a particle of a size larger than or equal to the acceptable value is attached to the base layer 1, the substrate 9 transitions to a substrate cleaning step (not illustrated) or a particle removal step (not illustrated). In the substrate cleaning step (not illustrated), the substrate 9 is chemically cleaned or dry-cleaned, thereby the particle attached to the base layer 1 is removed. In the particle removal step (not illustrated), the particle of the size larger than or equal to the acceptable value is removed from the base layer 1 using an adhesive or laser irradiation.

In FIG. 9, after particles on the base layer 1 are measured in step S10, then in step S7, the in-plane distribution of the film thickness of the base layer 1 is measured. After the in-plane distribution of the film thickness of the base layer 1 is measured, then in step S11, the measured value of the in-plane distribution of the film thickness of the base layer 1 is fed back to the particle detection apparatus 53. The particle detection apparatus 53 optimizes the particle detection condition, based on information regarding the fed back in-plane distribution of the film thickness of the base layer 1.

The acceptable particle size depends on the film thickness of the base layer 1. In general, the base layer 1 is composed of a softer material than that of the mold 6. For example, quartz is used as the mold 6, and an organic substance, such as SOC, is used as the base layer 1. Even if particles are attached to the base layer 1, the base layer 1 functions as a cushion to prevent the mold 6 from being destroyed. If the film thickness of the base layer 1 becomes smaller, the function as a cushion becomes weaker. Thus, the base layer 1 can only prevent smaller particles from destroying the mold 6. The particle detection sensitivity of the particle detection apparatus 53 is increased so that particles of smaller sizes can be detected, whereby it is possible to prevent the mold 6 from being destroyed by particles. Meanwhile, the increase in the particle detection sensitivity also increases noise level. This causes a detection error. In response, based on the in-plane distribution of the film thickness of the base layer 1, the value of the acceptable particle size in the particle detection apparatus 53 is increased or decreased. In an area where the film thickness of the base layer 1 is large, particles of larger sizes are detected. In an area where the film thickness of the base layer 1 is small, particles of smaller sizes are detected. This can reduce noise level while preventing the mold 6 from being destroyed by particles.

In the imprint method as described above, the measured value of the in-plane distribution of the film thickness of the base layer 1 is measured, and based on the measurement result, a detection condition for particle detection through the base layer 1 is determined. That is, it becomes possible to prevent the mold 6 from being destroyed by particles and to improve the accuracy of the position adjustment between the substrate 9 and the mold 6, by feeding back the measurement result to the particle detection apparatus 53.

Next, a description is given of a method for manufacturing an article (e.g., a semiconductor integrated circuit (IC) element, a liquid crystal display element, and microelectromechanical systems (MEMS)) using the imprint apparatus. The article is manufactured using the mold by performing the step of imprinting a substrate (e.g., a wafer, and a glass substrate) to which a photosensitizing agent is applied, the step of exposing the substrate, the step of developing the substrate (the photosensitizing agent), and the step of processing the developed substrate in other known steps. The processing in the other known steps includes etching, imprint material removal, dicing, bonding, and packaging. According to this article manufacturing method, a higher-grade article can be manufactured than that manufactured by a conventional method.

While desirable exemplary embodiments of the present disclosure have been described above, the present disclosure is not limited to these exemplary embodiments, but can be modified and changed in various manners within the scope of the present disclosure.

According to the present disclosure, it is possible to provide a molding method having an advantage in the position adjustment between a substrate and a mold in a plurality of different areas on the substrate.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-059215, filed Mar. 26, 2019, which is hereby incorporated by reference herein in its entirety.

What is claimed is:

1. A molding method for placing a curable composition on a substrate including a base layer on a surface of the substrate and obtaining a cured product molded on the substrate using a mold, the molding method comprising:
making position adjustment between the mold and the substrate in a state where the mold and the base layer of the substrate are in contact with the curable composition;
measuring an in-plane distribution of a shearing force generated when the position adjustment is made, or an in-plane distribution of a film thickness of the base layer; and
determining an application condition of the base layer or a detection condition for alignment detection through the base layer based on a result of at least one of the in-plane distribution of the shearing force and the in-plane distribution of the film thickness of the measuring step.

2. The molding method according to claim 1, wherein the measured in-plane distribution of the shearing force is a distribution of measured values of the shearing force generated in the curable composition placed on the base layer, and the measured values are obtained from a plurality of areas on the substrate.

3. The molding method according to claim 1, wherein in the measuring step, the in-plane distribution of the shearing force is measured, and in the determining step, the application condition of the base layer is determined based on a result of measuring the in-plane distribution of shearing force.

4. The molding method according to claim 1, wherein in determining the application condition, the film thickness of the base layer is fed back to the application condition of the base layer.

5. The molding method according to claim 1, wherein the application condition of the base layer is an application condition obtained by changing the film thickness of the base layer such that a difference in height in the distribution of the shearing force between a plurality of areas on the substrate becomes small.

6. The molding method according to claim 1, wherein the application condition is determined such that the film thickness of the base layer increases in response to an increase in the shearing force generated in a peripheral direction from a center of the substrate.

7. The molding method according to claim 1, further comprising detecting a positional shift between the substrate and the mold,
wherein a wavelength and a light intensity of alignment light for use in the detection are determined based on the application condition of the base layer.

8. The molding method according to claim 1, further comprising detecting a particle on the base layer by emitting light to the substrate,
wherein a particle detection sensitivity in the detecting step is determined based on the application condition of the base layer.

9. An imprint method including the molding method according to claim 1,
wherein the mold includes a uneven pattern on a surface of the mold, and
wherein the mold is for forming on the substrate a cured product onto which the uneven pattern of the mold is transferred.

10. A method for manufacturing an article, the method comprising:
forming a pattern on the substrate using the imprint method according to claim 9; and
processing the substrate on which the pattern is formed in the forming,
wherein an article including at least a part of the processed substrate is manufactured.

11. A molding apparatus for bringing a mold into contact with a curable composition on a substrate and curing the curable composition, the molding apparatus comprising:
a position adjustment unit configured to make position adjustment between the mold and the substrate, in a state where the mold and a base layer of the substrate are in contact with the curable composition;
a measurement unit configured to measure an in-plane distribution of a shearing force generated when the position adjustment is made, or an in-plane distribution of a film thickness of the base layer; and
a control unit configured to determine an application condition of the base layer based on a result of at least one of the in-plane distribution of the shearing force and the in-plane distribution of the film thickness obtained by the measurement unit.

12. A molding apparatus for bringing a mold into contact with a curable composition on a substrate and curing the curable composition, the molding apparatus comprising:
a position adjustment unit configured to make position adjustment of the mold and the substrate, in a state where the mold and a base layer of the substrate are in contact with the curable composition;
a measurement unit configured to measure an in-plane distribution of a film thickness of the base layer; and
a control unit configured to determine an application condition of the base layer based on a result of measurement obtained by the measurement unit.

13. An article manufacturing system including the molding apparatus according to claim 11 and an application apparatus for manufacturing a substrate having a base layer, wherein the substrate is applied to the molding apparatus, the article manufacturing system comprising:
a feedback unit configured to determine an application condition of the application apparatus based on a result of measurement due to a distribution of a shearing force obtained by the molding apparatus.

14. An article manufacturing system including the molding apparatus according to claim 12 and an application apparatus for manufacturing a substrate, which is supplied to the molding apparatus, on which a base layer is applied the article manufacturing system comprising:
a feedback unit configured to determine an application condition of the application apparatus based on a result of measurement due to a distribution of a shearing force obtained by the molding apparatus.
